(19) United States
(12) Patent Application Publication
(10) Pub. No.: US 2022/0212094 A1
(43) Pub. Date: Jul. 7, 2022

(54) Electronic Game Table

(71) Applicants: Andrew Onulak, Wiggins, CO (US); Alexander Paul, Denver, CO (US)

(72) Inventors: Andrew Onulak, Wiggins, CO (US); Alexander Paul, Denver, CO (US)

(21) Appl. No.: 17/141,815

(22) Filed: Jan. 5, 2021

(51) Int. Cl. A63F 7/26; A63F 11/00; A63F 13/26

(52) U.S. Cl. CPC A63F 7/265; A63F 2007/3674; A63F 13/26; A63F 11/0051

(57) ABSTRACT

The electronic game table is a table setup, along with an app, that facilitates the play of role-playing games and other board games by players either in present, or connected remotely. The movements of pieces by players in person are recognized by the table, and the events are sent to the app. On the other side, remote players make changes to the board through the app, which contacts the physical electronic table, and the table automatically moves the corresponding pieces as the app directs. In addition, the table has built-in speakers to give audio output to physically-present players, and a OLED screen embedded in the table top as to give visual response to the users or otherwise simulate the playing board.

### BACKGROUND

A role-playing game is a game in which players assume the roles of characters in a fictional setting. Players take responsibility for acting out these roles within a narrative, either through literal acting, or through a process of structured decision-making regarding character development. Actions taken within many games succeed or fail according to a formal system of rules and guidelines. There have been no products available as original equipment or as an aftermarket to address this problem.

One common feature of many RPGs is the role of gamemaster, a participant who has special duties to present the fictional setting, arbitrate the results of character actions, and maintain the narrative flow. In tabletop and live action RPGs the GM performs these duties in person. In video RPGs many of the functions of a GM are fulfilled by the game engine. However some multi-player video RPGs also allow for a participant to take on a GM role through a visual interface called a GM toolkit, albeit with abilities limited by the available technology. There have been no products available as original equipment or as an aftermarket to address this problem either.

There exists a need for an electronic game table that is not being met by any known or disclosed device or system of present.

### SUMMARY OF THE INVENTION

The electronic game table is a table setup, along with an app, that facilitates the play of role-playing games and other board games by players either in present, or connected remotely. The movements of pieces by players in person are recognized by the table, and the events are sent to the app. On the other side, remote players make changes to the board through the app, which contacts the physical electronic table, and the table automatically moves the corresponding pieces as the app directs. In addition, the table has built-in speakers to give audio output to physically-present players, and a OLED screen embedded in the table top as to give visual response to the users or otherwise simulate the playing board.

### BRIEF DESCRIPTION OF THE DRAWINGS

FIG. 1 is an above view of the table with the top surface removed, in accordance with an embodiment of the present disclosure.

FIG. 2 is a view of a magnetic base plate with its cap removed, in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term NFC is used to refer to near field communication via a set of communication protocols for communication between two electronic devices over a distance of 4 cm or less. NFC offers a low-speed connection with simple setup that can be used to bootstrap more-capable wireless connections. The term OLED refers to organic light emitting diodes containing thin flexible sheets of an organic electroluminescent material used for visual displays.

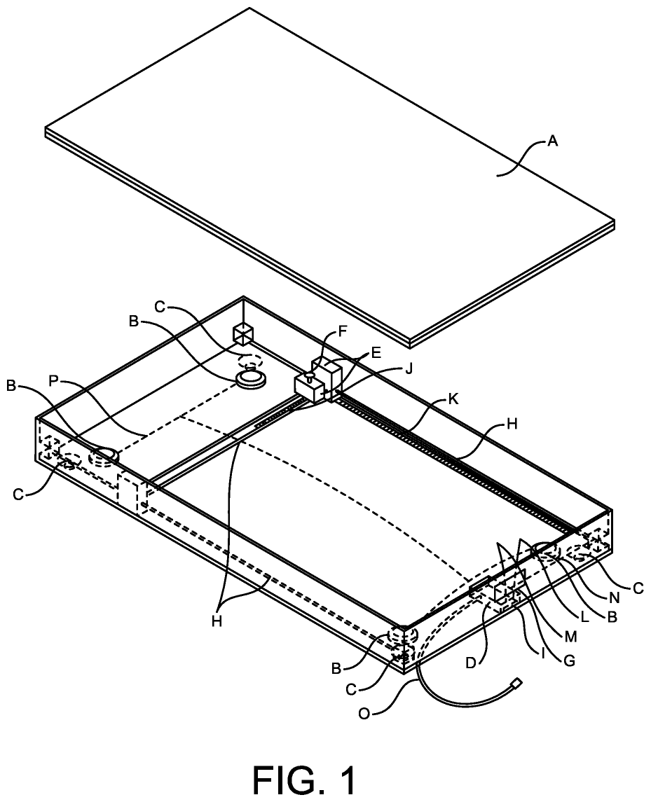

FIG. 1 is an above view of the table with the top surface removed, in accordance with an embodiment of the present disclosure. The three-layered table top A, comprising of two glass layers surrounding the OLED (organic light emitting diode) screen in the middle, comes in several different sizes and is removed from the table to show the insides. At each of the four inner corners of the table are downward facing speakers B, adjacent to the four feet C of the table. On one of the short edges of the rectangular table is a computer with housing and connections D. The computer controls the speakers and the movement of the magnetic piston F and its carriage E along the rail system H. There are two tracks, each with cable chains. One of the cable chains K runs along the long edge of the table. The other cable chain J runs perpendicularly to the first, parallel to the short edge of the table. Said computer can also give feedback and receive input from the users by means of an external screen G on the same short edge, connected by the touchscreen cables M. Furthermore, the computer has abutting USB ports I. The computer receives power by the detachable power plug O. The computer powers the OLED top screen by the OLED cables L. The computer powers the belt system by the belt system power cables N. The computer powers the speakers by speaker cables P.

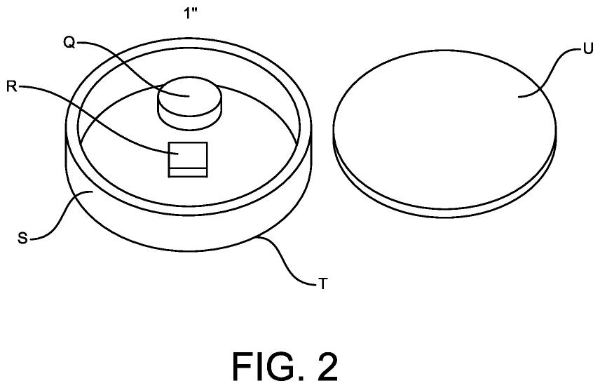

FIG. 2 is a view of a magnetic base plate puck with its cap removed, in accordance with an embodiment of the present disclosure. The outer puck S, which is about 1 inch in diameter, contains a wireless NFC (near field communications) tag R and a magnet Q to move game pieces on the table. The puck has a soft fabric or felt bottom T to prevent damage to the table.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A game table comprising:
a y axis movement mechanism powered by a first stepper motor;
an x axis movement mechanism powered by a second stepper motor;
a magnetic piston disposed at a juncture of the y axis movement and the x axis movement;
a magnetic puck disposed a surface of the game table and configured to track the magnetic piston;
a first microprocessor configured to drive the y axis movement and the x axis movement and the magnetic puck via electronic signals from another microprocessor over a wireless channel.

2. The game table of claim 1, further comprising a plurality of downward facing speakers in relation to a top of the game table whereupon the magnetic puck travels.

3. The game table of claim 1, further comprising a multi-layer cover comprising a layer of glass and an OLED layer for a topside of the game table whereupon the magnetic puck travels.

4. The game table of claim 1, further comprising a touch screen disposed on a wall of the game table and configured to interface with the first microprocessor.

5. The game table of claim 1, further comprising a cable chain and a movement carriage and a stepper motor for each of the y axis and the x axis movement mechanisms.

6. The game table of claim 1, further comprising an NFC tag in the magnetic puck and configured to wirelessly communicate with the first microprocessor.

7. The game table of claim 1, further comprising a felt-like soft fabric bottom on the magnetic puck having a low friction coefficient in relation to a top of the game board.

8. The game table of claim 1, further comprising a main carriage configured to drive the magnetic piston at the juncture of the y axis movement and the x axis movement.

9. The game table of claim 1, further comprising a low voltage power supply housed with a plurality of sidewalls, a bottom and a top of the game table and powered itself by a domestic alternating current electricity and direct current battery.

10. The game table of claim 1, further comprising a computer program product configured to drive the magnetic piston and thereby move the magnetic puck based on the signals from the other microprocessor over the wireless channel.

11. The game table of claim 1, further comprising a computer program product configured to drive the magnetic piston based on a movement of a second puck on a second game table via a signaling between the first microprocessor and the other microprocessor.

12. The game table of claim 1, further comprising the magnetic puck being responsive to a plurality of commands from a first user via the first microprocessor.

13. The game table of claim 1, further comprising a second puck being responsive to a plurality of commands from a second user via the other microprocessor.

14. The game table of claim 1, wherein the magnetic piston engages with and disengages with a plurality of magnetic pucks each having unique electronic properties.

15. The game table of claim 1, wherein the magnetic puck further comprises an avatar image and a unique electronic signature.

16. The game table of claim 1, further comprising a plurality of magnetic pucks each comprising unique electronic properties readable by a main carriage configured to drive the magnetic piston.

17. The game table of claim 1, further comprising a plurality of independent rail systems housed within a bottom and a top and sides of the game table, wherein each rail system comprises an x and a y axis movement mechanism and a magnetic piston.

18. The game table of claim 1, further comprising a top for the magnetic puck movement thereon, a bottom and a plurality of side walls there between.

19. The game table of claim 1, further comprising a plurality of table legs attachable to a bottom of the game table and configured to support an extensible operation of the game table from a floor surface.

20. The game table of claim 1, further comprising a plurality of cables for a electric power supply of the axis movement mechanisms and the magnetic piston and a signal transfer from the first microprocessor there between.
